(19) United States
(12) Patent Application Publication
(10) Pub. No.: US 2022/0347868 A1
(43) Pub. Date: Nov. 3, 2022

(54) Wrist Device, Industrial Robot And Method

(71) Applicant: ABB Schweiz AG, Baden (CH)

(72) Inventors: Stefan Danielsson, Västerås (SE); Adam Bovin, Västerås (SE); Daniel Lundbäck, Västerås (SE); Tommy Thors, Västerås (SE); Jakob Weström, Västerås (SE)

(21) Appl. No.: 17/753,720

(22) PCT Filed: Oct. 3, 2019
(86) PCT No.: PCT/EP2019/076836

§ 371 Date: Mar. 11, 2022

(51) Int. Cl. B25J 17/02; B25J 9/10; B25J 19/00

(52) U.S. Cl. CPC B25J 17/0283; B25J 9/1035; B25J 19/007

(57) ABSTRACT

A wrist device for an industrial robot, the wrist device including a wrist housing; a first member; a second member; a first pinion rotatable about a first pinion axis; a first crown wheel for driving the first member, the first crown wheel meshing with the first pinion; a second pinion rotatable about a second pinion axis; a second crown wheel for driving the second member, the second crown wheel meshing with the second pinion; and an integral pinion housing fixedly attached to the wrist housing, the pinion housing supporting the first pinion for rotation about the first pinion axis and supporting the second pinion for rotation about the second pinion axis. An industrial robot including a wrist device, and a method of assembling a wrist device for an industrial robot, are also provided.

### TECHNICAL FIELD

The present disclosure generally relates to a wrist device. In particular, a wrist device for an industrial robot, an industrial robot comprising a wrist device, and a method of assembling a wrist device for an industrial robot, are provided.

### BACKGROUND

An industrial robot may comprise a manipulator programmable in three or more axes. Some known industrial robots comprise a wrist housing in which a first pinion of a first hypoid gear and a second pinion of a second hypoid gear are arranged. The first pinion may be arranged to drive a first member relative to the wrist housing and the second pinion may be arranged to drive a second member relative to the wrist housing. Hypoid gears enable high torque to be generated.

In some industrial robots, a first bearing rotationally supports a first pinion and a second bearing rotationally supports a second pinion, where respective outer races of the first bearing and the second bearing are attached directly to the wrist housing. For such solutions, it is quite complicated to achieve a small backlash to the first pinion and to the second pinion. To this end, manual measurements and addition of shims are typically required.

In some other industrial robots, the first pinion is rotationally supported in a first pinion housing and the second pinion is rotationally supported in a second pinion housing, separate from the first pinion housing. Each of the first pinion housing and the second pinion housing may be attached to the wrist housing by means of screws. By adjusting the position of the first pinion housing, backlash between the first pinion and a first crown wheel can be reduced. By adjusting the position of the second pinion housing, backlash between the second pinion housing and a second crown wheel can be reduced. In this way, the use of shims to reduce backlash can be avoided.

EP 1938930 B1 discloses a robot arm for an industrial robot, comprising a first arm part and a second arm part, wherein the second arm part is rotatably journaled in the first arm part for rotation about a first axis of rotation. The robot arm further comprises a first pinion, a second pinion, a first coupling housing the first pinion and a second coupling housing the second pinion.

### SUMMARY

One object of the present disclosure is to provide a wrist device for an industrial robot, which wrist device has a compact design.

A further object of the present disclosure is to provide a wrist device for an industrial robot, which wrist device has a simple design.

A still further object of the present disclosure is to provide a wrist device for an industrial robot, which wrist device enables a simple and/or cheap manufacture.

A still further object of the present disclosure is to provide a wrist device for an industrial robot, which wrist device enables a simple and/or cheap assembly.

A still further object of the present disclosure is to provide a wrist device for an industrial robot, which wrist device enables an improved precision of the industrial robot.

A still further object of the present disclosure is to provide a wrist device for an industrial robot, which wrist device enables backlash to be more efficiently reduced or eliminated.

A still further object of the present disclosure is to provide a wrist device for an industrial robot, which wrist device enables a simple reduction or elimination of backlash.

A still further object of the present disclosure is to provide a wrist device for an industrial robot, which wrist device solves several or all of the foregoing objects in combination.

A still further object of the present disclosure is to provide an industrial robot comprising a wrist device, which industrial robot has improved precision.

A still further object of the present disclosure is to provide an industrial robot comprising a wrist device, which industrial robot solves one, several or all of the foregoing objects.

A still further object of the present disclosure is to provide a method of assembling a wrist device for an industrial robot, which method solves one, several or all of the foregoing objects.

According to one aspect, there is provided a wrist device for an industrial robot, the wrist device comprising a wrist housing; a first member movable relative to the wrist housing; a second member movable relative to the wrist housing and relative to the first member; a first pinion rotatable about a first pinion axis; a first crown wheel for driving the first member, the first crown wheel meshing with the first pinion; a second pinion rotatable about a second pinion axis; a second crown wheel for driving the second member, the second crown wheel meshing with the second pinion; and an integral pinion housing fixedly attached to the wrist housing, the pinion housing supporting the first pinion for rotation about the first pinion axis and supporting the second pinion for rotation about the second pinion axis.

The integral pinion housing is a common pinion housing for the first pinion and the second pinion. Thus, instead of providing a dedicated first pinion housing and a dedicated second pinion housing, separate from the first pinion housing, the wrist device according to the present disclosure utilizes a common pinion housing for both the first pinion and the second pinion. This has several advantages.

In prior art solutions employing a dedicated first pinion housing and a second pinion housing, both a material thickness of the first pinion housing and a material thickness of the second pinion housing are provided between the first pinion and the second pinion. In addition, some play is required between the first pinion housing and the second pinion housing in order to mount these components. By providing a common pinion housing according to the present disclosure, less “pinion housing material” needs to be provided between the first pinion and the second pinion. Furthermore, no play needs to be provided between a first pinion housing and a second pinion housing. Thereby, the first pinion can be arranged closer to the second pinion and the wrist device can be made more compact.

Furthermore, the utilization of a dedicated first pinion housing and a dedicated second pinion housing according to the prior art complicates manufacture and assembly of the industrial robot and requires more storage space. With the wrist device according to the present disclosure in contrast, the common pinion housing can be manufactured and assembled in one part, which facilitates manufacture and assembly of the industrial robot and requires less storage space.

Furthermore, due to the provision of the integral pinion housing receiving both the first pinion and the second pinion, the pinion housing is larger than a single pinion housing dedicated for either a first pinion or a second pinion. A larger housing provides higher counter torques. Thereby, the wrist device according to the present disclosure enables a stiffer structure of the wrist device. This in turn improves the precision of the industrial robot.

Furthermore, in prior art solutions employing a dedicated first pinion housing and a second pinion housing, a position of the first pinion housing is adjusted to remove backlash between the first pinion and a first crown wheel, and a position of the second pinion housing is adjusted to remove backlash between the second pinion and a second crown wheel. Thus, backlash to the first pinion and to the second pinion cannot be reduced simultaneously. By means of the integral pinion housing according to the present disclosure in contrast, the first pinion can be brought into meshing engagement with the first crown wheel and the second pinion can be brought into meshing engagement with the second crown wheel with one single motion of the integral pinion housing. The motion may for be a rotational movement and/or a translational movement of the integral pinion housing, e.g. a translational movement perpendicular to the first pinion axis and to the second pinion axis.

With integral pinion housing is meant that the pinion housing forms a rigid unit, as opposed to two separate pinion housings. The integral pinion housing is rigid prior to being attached to the wrist housing and prior to receiving the first pinion and the second pinion.

The first pinion and the first crown wheel may form a first bevel gear. Each of the first pinion and the first crown wheel may thus comprise teeth for the meshing engagement. The first pinion and the first crown wheel may for example form a first hypoid gear, i.e. such that the first pinion axis is offset with respect to a rotational axis of the first crown wheel.

The second pinion and the second crown wheel may form a second bevel gear. Each of the second pinion and the second crown wheel may thus comprise teeth for the meshing engagement. The second pinion and the second crown wheel may for example form a second hypoid gear, i.e. such that the second pinion axis is offset with respect to a rotational axis of the second crown wheel.

Each of the first member and the second member may be a link member of the industrial robot. Throughout the present disclosure, the first member may be referred to as a proximal member and the second member may be referred to as a distal member. Furthermore, the prefixes “first” and “second” may be referred to as “proximal” and “distal”, respectively, throughout the present disclosure. The first member and the second member may for example be constituted by a fifth link member and a sixth link member, respectively, of the industrial robot. In this case, the wrist housing may be fixed with respect to a fourth link member of the industrial robot. However, the wrist housing, the first member and the second member may be provided at different link members of an industrial robot.

The wrist housing may be a tilt housing. The pinion housing, the first pinion and the second pinion may be accommodated inside the wrist housing.

The first member may move relative to the wrist housing by means of a rotational movement or a translational movement. The second member may move relative to the wrist housing and relative to the first member by means of a rotational movement or a translational movement.

The wrist device may further comprise a third bevel gear. By means of the third bevel gear, rotation of the second crown wheel can be transmitted to a movement of the second member relative to the first member.

The first crown wheel may be arranged to rotate about a first axis. In this case, the first pinion and the second pinion may be offset in a direction parallel with the first axis. In this way, the interior of the wrist housing can be more effectively utilized and the wrist device can thereby be made more compact. Furthermore, the offset distance between the first pinion and the second pinion in the direction parallel with the first axis can be reduced in comparison with a prior art wrist housing comprising a dedicated first pinion housing and a dedicated second pinion housing, separate from the first pinion housing.

The wrist device may further comprise at least one first bearing rotationally supporting the first pinion inside the pinion housing for rotation about the first pinion axis, and at least one second bearing rotationally supporting the second pinion inside the pinion housing for rotation about the second pinion axis. According to one example, the at least one first bearing comprises a primary first bearing and a secondary first bearing, and the at least one second bearing comprises a primary second bearing and a secondary second bearing. The secondary first bearing may be arranged between the primary second bearing and the first crown wheel. The secondary second bearing may be arranged between the primary second bearing and the second crown wheel.

The primary first bearing and the primary second bearing may for example each be an angular contact ball bearing. The secondary first bearing and the secondary second bearing may for example each be a needle roller bearing.

According to a further example, the at least one first bearing comprises only one bearing, e.g. the primary first bearing, and the at least one second bearing comprises only one bearing, e.g. the primary first bearing.

The pinion housing may comprise a first opening and a second opening. In this case, one of the at least one first bearing may be arranged in the first opening and one of the at least one second bearing may be arranged in the second opening. In case the first bearing comprises a primary first bearing and a secondary first bearing, and the second bearing comprises a primary second bearing and a secondary second bearing, the primary first bearing may be arranged in the first opening and the primary second bearing may be arranged in the second opening. By means of the integral pinion housing, a material thickness between the first opening and the second opening can be reduced. Thereby, the primary first bearing and the primary second bearing can be brought closer to each other. This further contributes to a compact design of the wrist housing. According to one variant, the first opening opens into the second opening. In this way, material between the first opening and the second opening can be entirely removed.

The pinion housing may comprise a first through hole and a second through hole. In this case, the first pinion may pass through the first through hole and the second pinion may pass through the second through hole. The first through hole may open into the first opening and the second through hole may open into the second opening. The secondary first bearing may rotationally support the first pinion inside the first through hole for rotation about the first pinion axis, and the secondary second bearing may rotationally support the second pinion inside the second through hole for rotation about the second pinion axis. In case the primary first bearing and the primary second bearing are angular contact bearings and the secondary first bearing and the secondary second bearing are needle roller bearings; some material can be provided in the pinion housing between the first through hole and the second through hole since needle roller bearings typically have smaller outer diameters than angular contact bearings.

The pinion housing may be fixedly attached to the wrist housing by means of a fastening arrangement, such as by one or more fasteners. As an alternative to fasteners, the fastening arrangement may for example comprise one or more wedges, or one or more clamps, for fixedly attaching the pinion housing to the wrist housing.

The pinion housing may be repositionable relative to the wrist housing after loosening the fastening arrangement. The wrist device may thus comprise a fastening arrangement for fixedly attaching the pinion housing to the wrist housing. In case a fastening arrangement comprising screws is employed, the pinion housing may comprise slots for passing a respective screw therethrough. A play may be provided between a shaft of the screw and an associated slot in the pinion housing. In this way, the pinion housing can be moved relative to the wrist housing while the screws are threadingly engaging the wrist housing.

The pinion housing may be formed in one piece. The pinion housing may be formed in one piece of material, for example by means of casting. Thus, the pinion housing may be monolithic, e.g. made of metal. Alternatively, the pinion housing may be formed in one piece of a composite material.

The first pinion axis and the second pinion axis may be substantially parallel, or parallel.

The first crown wheel may be arranged to rotate about a first axis. In this case, the first member and the first crown wheel may be fixed with respect to each other. Thus, the first member may be rotatable relative to the wrist housing.

Each of the first crown wheel and the second crown wheel may be arranged to rotate about a first axis.

The first crown wheel may be arranged to rotate about a first axis. In this case, the second member may be arranged to rotate about a second axis perpendicular to the first axis. Thus, the second member may be rotatable relative to the wrist housing and relative to the first member. The second axis may or may not intersect with the first axis.

According to a further aspect, there is provided an industrial robot comprising a wrist device according to the present disclosure. According to one example, the industrial robot is a welding robot.

The industrial robot may comprise a manipulator programmable in three or more axes. The industrial robot may for example comprise six or seven axes. In these cases, the first member may be movable relative to the wrist housing about a fifth axis and the second member may be movable relative to the wrist housing about a sixth axis. However, the wrist device can be provided at alternative axes of the industrial robot.

According to a further aspect, there is provided a method of assembling a wrist device for an industrial robot, the method comprising providing a wrist housing having a first crown wheel and a second crown wheel; providing an integral pinion housing rotationally supporting a first pinion and rotationally supporting a second pinion; and fixedly attaching the pinion housing to the wrist housing such that the first pinion meshes with the first crown wheel and the second pinion meshes with the second crown wheel. The method according to the present disclosure may be carried out with any wrist device according to the present disclosure.

The method may further comprise translationally moving the pinion housing such that the first pinion meshes with the first crown wheel and the second pinion meshes with the second crown wheel prior to fixedly attaching the pinion housing to the wrist housing.

The method may further comprise rotating the pinion housing such that the first pinion meshes with the first crown wheel and the second pinion meshes with the second crown wheel prior to fixedly attaching the pinion housing to the wrist housing.

### BRIEF DESCRIPTION OF THE DRAWINGS

Further details, advantages and aspects of the present disclosure will become apparent from the following embodiments taken in conjunction with the drawings, wherein:

FIG. 1: schematically represents a side view of an industrial robot comprising a wrist device;

FIG. 2: schematically represents a cross-sectional side view of the wrist device;

FIG. 3: schematically represents a perspective view of the wrist device; and FIG. 4: schematically represents a cross-sectional top view of the wrist device.

### DETAILED DESCRIPTION

In the following, a wrist device for an industrial robot, an industrial robot comprising a wrist device, and a method of assembling a wrist device for an industrial robot, will be described. The same or similar reference numerals will be used to denote the same or similar structural features.

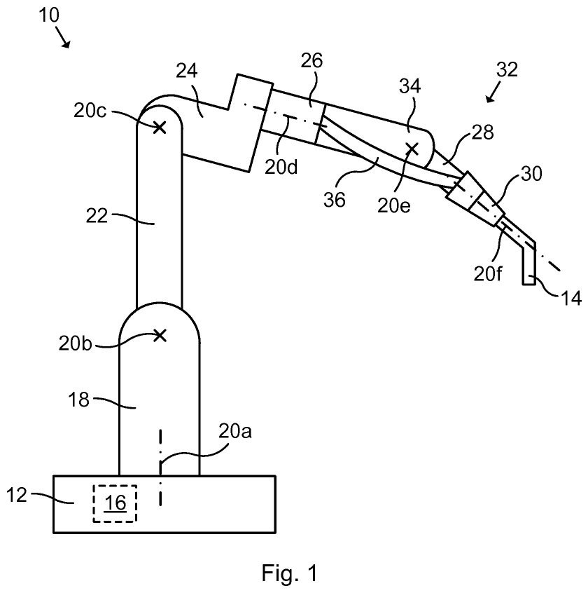

FIG. 1 schematically represents a side view of an industrial robot 10. The industrial robot 10 is here exemplified as a six-axis industrial robot but the present disclosure is not limited to this type of industrial robot. An industrial robot according to the present disclosure may comprise a manipulator movable in at least three axes.

The industrial robot 10 of this example comprises a base member 12, a tool 14, and a control system 16, such as a robot controller. The industrial robot 10 further comprises a link member 18 distal of the base member 12 and rotatable around a vertical axis 20a relative to the base member 12, a link member 22 distal of the link member 18 and rotatable around a horizontal axis 20b relative to the link member 18, a link member 24 distal of the link member 22 and rotatable around a horizontal axis 20c relative to the link member 22, a link member 26 distal of the link member 24 and rotatable around an axis 20d relative to the link member 24, a link member 28 distal of the link member 26 and rotatable around an axis 20e relative to the link member 26, and a link member 30 distal of the link member 28 and rotatable around an axis 20f relative to the link member 28. The link member 30 comprises an interface (not denoted) to which the tool 14 is attached.

The industrial robot 10 comprises a wrist device 32. The wrist device 32 of this example comprises a wrist housing 34, the link member 28 and the link member 30. The wrist housing 34 is fixed with respect to the link member 26.

In the following, the link member 28 will be referred to as a first member 28, the link member 30 will be referred to as a second member 30, although the first member 28 is provided at the fifth axis and the second member 30 is provided at the sixth axis. Correspondingly, the axis 20e will be referred to as a first axis 20e and the axis 20f will be referred to as a second axis 20f. The wrist housing 34, the first member 28 and the second member 30 may however be provided at different link members of the industrial robot 10. In any case, the first member 28 is proximal of the second member 30.

The industrial robot 10 of this example is a welding robot. The tool 14 is thus a weld tool. The industrial robot 10 of this example further comprises a cable harness 36. The cable harness 36 may for example comprise electric power cables, electric signal cables, hoses for compressed air and coolant etc. The cable harness 36 extends from the link member 26, outside of the wrist housing 34, and to the first member 28.

In FIG. 1, the wrist housing 34 is a tilt housing. The first member 28 is rotatable relative to the wrist housing 34 about the first axis 20e. The second member 30 is rotatable relative to the first member 28, and also relative to the wrist housing 34, about the second axis 20f. In this example, the axis 20d and the first axis 20e cross each other at right angles. Furthermore, the axis 20d and the second axis 20f are arranged in the same plane. Consequently, the first axis 20e and the second axis 20f intersect and are perpendicular to each other.

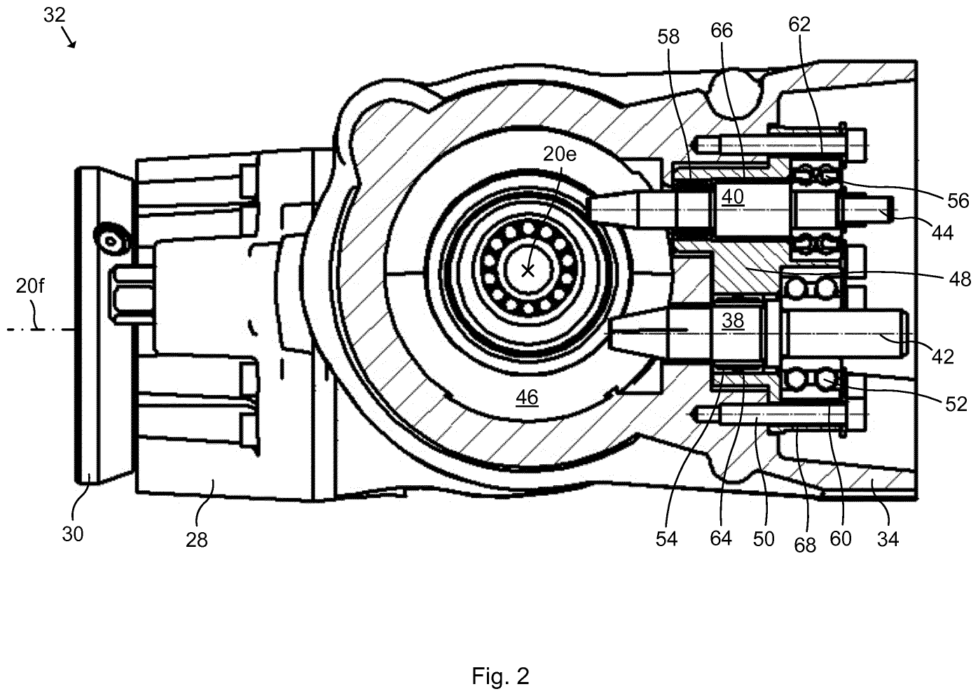

FIG. 2 schematically represents a cross-sectional side view of the wrist device 32. As shown in FIG. 2, the wrist device 32 comprises a first pinion 38 and a second pinion 40. The first pinion 38 is rotatable about a first pinion axis 42. The second pinion 40 is rotatable about a second pinion axis 44. In this example, the first pinion axis 42 and the second pinion axis 44 are parallel.

The wrist device 32 further comprises a first crown wheel 46. The first pinion 38 meshes with the first crown wheel 46. The first crown wheel 46 is arranged to drive the first member 28 relative to the wrist housing 34. In this example, the first crown wheel 46 is fixed with respect to the first member 28 such that the first crown wheel 46 and the first member 28 rotate in common about the first axis 20e. The first pinion 38 and the first crown wheel 46 form a first hypoid gear.

The wrist device 32 further comprises a second crown wheel 70 (see FIG. 4). The second pinion 40 meshes with the second crown wheel 70. The second crown wheel 70 is arranged to drive the second member 30 relative to the first member 28, and relative to the wrist housing 34. The second pinion 40 and the second crown wheel 70 form a second hypoid gear.

The wrist device 32 further comprises an integral pinion housing 48. The pinion housing 48 is fixedly attached to the wrist housing 34. In this example, the pinion housing 48 is fixedly attached to the wrist housing 34 by means of a fastening arrangement, here exemplified as screws 50. Both the first pinion 38 and the second pinion 40 extend through the same pinion housing 48. The pinion housing 48 is thus a common pinion housing 48 for both the first pinion 38 and the second pinion 40. Furthermore, the pinion housing 48, the first pinion 38 and the second pinion 40 are arranged inside the wrist housing 34.

The pinion housing 48 rotationally supports the first pinion 38 for rotation about the first pinion axis 42. The pinion housing 48 further rotationally supports the second pinion 40 for rotation about the second pinion axis 44. To this end, the pinion housing 48 of this example comprises two first bearings 52, 54 and two second bearings 56, 58. The two first bearings 52, 54 and the two second bearings 56, 58 are arranged inside the pinion housing 48.

The two first bearings 52, 54 rotationally support the first pinion 38 for rotation about the first pinion axis 42. The two first bearings 52, 54 are here exemplified as a primary first bearing 52 and a secondary first bearing 54. The primary first bearing 52 is an angular contact ball bearing and the secondary first bearing 54 is a needle roller bearing. The primary first bearing 52 takes both axial and radial loads (with respect to the first pinion axis 42) and the secondary first bearing 54 takes radial loads (with respect to the first pinion axis 42). As shown in FIG. 2, the secondary first bearing 54 is arranged between the primary first bearing 52 and the first axis 20e.

The two second bearings 56, 58 rotationally support the second pinion 40 for rotation about the second axis 20f. The two second bearings 56, 58 are here exemplified as a primary second bearing 56 and a secondary second bearing 58. In this example, the primary second bearing 56 is an angular contact ball bearing and the secondary second bearing 58 is a needle roller bearing. The primary second bearing 56 takes both axial and radial loads (with respect to the second pinion axis 44) and the secondary second bearing 58 takes radial loads (with respect to the second pinion axis 44). As shown in FIG. 2, the secondary second bearing 58 is arranged between the primary second bearing 56 and the first axis 20e.

The pinion housing 48 further comprises a first opening 60 and a second opening 62. The primary first bearing 52 is accommodated inside the first opening 60 and the primary second bearing 56 is accommodated inside the second opening 62. Due to the integrity of the pinion housing 48, only a very small material thickness is provided between the first opening 60 and the second opening 62.

The pinion housing 48 further comprises a first through hole 64 and a second through hole 66. As shown in FIG. 2, the first through hole 64 has a smaller diameter than the first opening 60 and the second through hole 66 has a smaller diameter than the second opening 62. Thereby, more material is provided in the pinion housing 48 between the first through hole 64 and the second through hole 66 than between the first opening 60 and the second opening 62.

The first through hole 64 extends from the first opening 60 to the opposite side of the pinion housing 48. The secondary first bearing 54 is accommodated inside the first through hole 64. The secondary first bearing 54 rotationally supports the first pinion 38 for rotation about the first pinion axis 42.

The second through hole 66 extends from the second opening 62 to the opposite side of the pinion housing 48. The secondary second bearing 58 is accommodated inside the second through hole 66. The secondary second bearing 58 rotationally supports the second pinion 40 for rotation about the second pinion axis 44.

The pinion housing 48 further comprises a plurality of slots 68. Each slot 68 extends through the pinion housing 48, in FIG. 2 generally parallel with the first pinion axis 42 and the second pinion axis 44. Each slot 68 is arranged to receive a shaft of the screw 50. Each slot 68 is however larger than the shaft of the screw 50. Thereby, if the screws 50 are loosened slightly, the position of the pinion housing 48 can be adjusted relative to the wrist housing 34 while the screws 50 are maintained in engagement with the wrist housing 34. That is, the pinion housing 48 can be adjusted by rotation and/or translation relative to the wrist housing 34 in a plane perpendicular to the first pinion axis 42 and the second pinion axis 44.

The industrial robot 10 further comprises a first drive unit (not shown) and a second drive unit (not shown). The first drive unit is arranged to rotationally drive the first pinion 38 and the second drive unit is arranged to rotationally drive the second pinion 40.

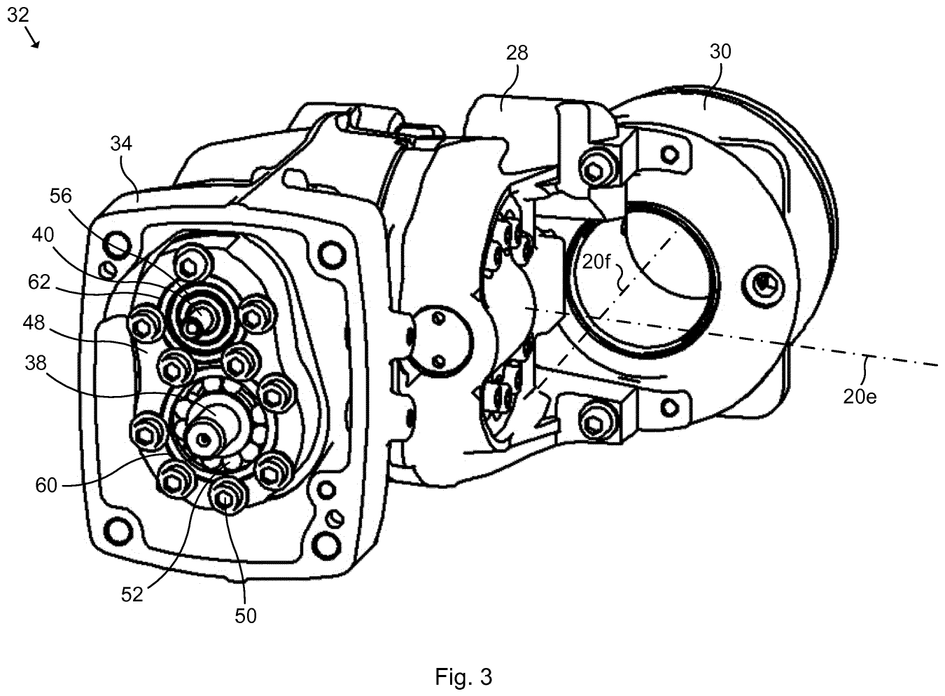

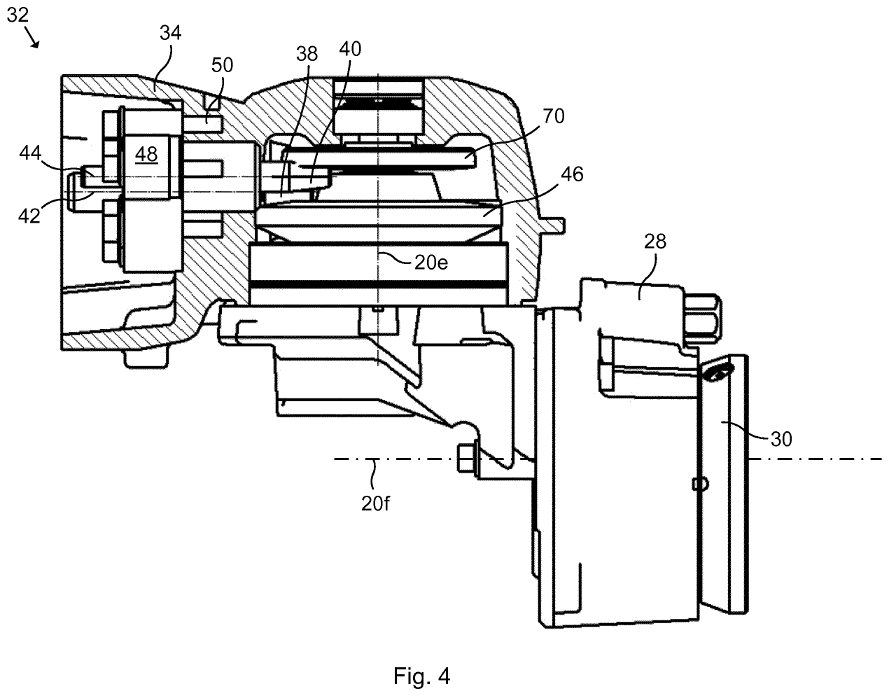

FIG. 3 schematically represents a perspective view of the wrist device 32. In FIG. 3, it can be seen that the first pinion 38 and the second pinion 40 are offset in a direction parallel with the first axis 20e.

The first pinion 38 and the second pinion 40 can be rotationally arranged in the pinion housing 48 at a site remote from the remaining industrial robot 10. The pinion housing 48 together with the first pinion 38 and the second pinion 40 can then be brought as one package into the wrist housing 34, e.g. linearly in a direction parallel with the second axis 20f in FIG. 3. The screws 50 can then be slightly screwed into the wrist housing 34. Prior to tightening the screws 50, the pinion housing 48 can be manually moved, e.g. rotated and translated, until both a backlash between the first pinion 38 and the first crown wheel 46, and a backlash between the second pinion 40 and the second crown wheel 70, are eliminated. The pinion housing 48 is then fixedly attached to the wrist housing 34 by tightening the screws 50. An operator can now manually rotate the first pinion 38 and the second pinion 40 and feel the response in the respective crown wheel to confirm that the backlash has been eliminated. Should backlash still prevail, the screws 50 can be slightly loosened and the pinion housing 48 adjusted once more.

As shown in FIG. 3, the primary first bearing 52 and the primary second bearing 56 are compactly arranged inside the pinion housing 48. Only a very thin piece of material is provided between the primary first bearing 52 and the primary second bearing 56.

Furthermore, since the pinion housing 48 encloses both the first pinion 38 and the second pinion 40, a largest distance between two screws 50 (over both the first pinion 38 and the second pinion 40) is relatively large. The pinion housing 48 can thereby provide large counter torques, despite the compact design of the wrist device 32.

FIG. 4 schematically represents a cross-sectional top view of the wrist device 32. In FIG. 4, the second crown wheel 70 can be seen. In this example, both the first crown wheel 46 and the second crown wheel 70 are arranged to rotate about the first axis 20e. The first crown wheel 46 has a larger diameter than the second crown wheel 70. An offset distance between the first pinion 38 and the first axis 20e is different than an offset distance between the second pinion 40 and the first axis 20e.

As shown in FIG. 4, the first pinion 38 and the second pinion 40 are arranged between the first crown wheel 46 and the second crown wheel 70. As can be gathered from FIG. 4, the first pinion 38 can be brought into meshing engagement with the first crown wheel 46 without backlash and the second pinion 40 can be brought into meshing engagement with the second crown wheel 70 without backlash by means of a single rotation of the pinion housing 48. FIG. 4 further shows that an offset distance between the first pinion 38 and the second pinion 40 in the direction parallel with the first axis 20e is relatively small. Thus, the wrist device 32 has a very compact design.

The wrist device 32 of this example further comprises a third bevel gear (not visible) for transmitting rotation of the second crown wheel 70 to a rotation of the second member 30 about the second axis 20f.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A wrist device for an industrial robot, the wrist device comprising:
a wrist housing;
a first member movable relative to the wrist housing;
a second member movable relative to the wrist housing and relative to the first member;
a first pinion rotatable about a first pinion axis;
a first crown wheel for driving the first member, the first crown wheel meshing with the first pinion;
a second pinion rotatable about a second pinion axis;
a second crown wheel for driving the second member, the second crown wheel meshing with the second pinion; and
an integral pinion housing fixedly attached to the wrist housing, the pinion housing supporting the first pinion for rotation about the first pinion axis and supporting the second pinion for rotation about the second pinion axis.

2. The wrist device according to claim 1, wherein the first crown wheel is arranged to rotate about a first axis, and wherein the first pinion and the second pinion are offset in a direction parallel with the first axis.

3. The wrist device according to claim 1, further comprising at least one first bearing rotationally supporting the first pinion inside the pinion housing for rotation about the first pinion axis, and at least one second bearing rotationally supporting the second pinion inside the pinion housing for rotation about the second pinion axis.

4. The wrist device according to claim 3, wherein the pinion housing comprises a first opening and a second opening, and wherein one of the at least one first bearing is arranged in the first opening and one of the at least one second bearing is arranged in the second opening.

5. The wrist device according to claim 1, wherein the pinion housing comprises a first through hole and a second through hole, wherein the first pinion passes through the first through hole and wherein the second pinion passes through the second through hole.

6. The wrist device according to claim 1, wherein the pinion housing is fixedly attached to the wrist housing by means of a fastening arrangement.

7. The wrist device according to claim 1, wherein the pinion housing is formed in one piece.

8. The wrist device according to claim 1, wherein the first pinion axis and the second pinion axis are parallel.

9. The wrist device according to claim 1, wherein the first crown wheel is arranged to rotate about a first axis, and wherein the first member and the first crown wheel are fixed with respect to each other.

10. The wrist device according to claim 1, wherein each of the first crown wheel and the second crown wheel is arranged to rotate about a first axis.

11. The wrist device according to claim 1, wherein the first crown wheel is arranged to rotate about a first axis, and wherein the second member is arranged to rotate about a second axis perpendicular to the first axis.

12. An industrial robot comprising a wrist device having:
a wrist housing;
a first member movable relative to the wrist housing;
a second member movable relative to the wrist housing and relative to the first member;
a first pinion rotatable about a first pinion axis;
a first crown wheel for driving the first member, the first crown wheel meshing with the first pinion;
a second pinion rotatable about a second pinion axis;
a second crown wheel for driving the second member, the second crown wheel meshing with the second pinion; and
an integral pinion housing fixedly attached to the wrist housing, the pinion housing supporting the first pinion for rotation about the first pinion axis and supporting the second pinion for rotation about the second pinion axis.

13. A method of assembling a wrist device for an industrial robot, the method comprising:
providing a wrist housing having a first crown wheel and a second crown wheel; Page 6
providing an integral pinion housing rotationally supporting a first pinion and rotationally supporting a second pinion; and
fixedly attaching the pinion housing to the wrist housing such that the first pinion meshes with the first crown wheel and the second pinion meshes with the second crown wheel.

14. The method according to claim 13, further comprising translationally moving the pinion housing such that the first pinion meshes with the first crown wheel and the second pinion meshes with the second crown wheel prior to fixedly attaching the pinion housing to the wrist housing.

15. The method according to claim 13, further comprising rotating the pinion housing such that the first pinion meshes with the first crown wheel and the second pinion meshes with the second crown wheel prior to fixedly attaching the pinion housing to the wrist housing.

16. The wrist device according to claim 2, further comprising at least one first bearing rotationally supporting the first pinion inside the pinion housing for rotation about the first pinion axis, and at least one second bearing rotationally supporting the second pinion inside the pinion housing for rotation about the second pinion axis.

17. The method according to claim 14, further comprising rotating the pinion housing such that the first pinion meshes with the first crown wheel and the second pinion meshes with the second crown wheel prior to fixedly attaching the pinion housing to the wrist housing.
